(19) United States
(12) Patent Application Publication
(10) Pub. No.: US 2007/0020088 A1
(43) Pub. Date: Jan. 25, 2007

(54) Turbine shroud segment impingement cooling on vane outer shroud

(75) Inventors: Eric Durocher, Vercheres (CA); Assaf Farah, Charlemagne (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: Pratt & Whitney Canada Corp.

(21) Appl. No.: 11/184,843

(22) Filed: Jul. 20, 2005

(51) Int. Cl. F03B 11/00

(52) U.S. Cl. 415/115

(57) ABSTRACT

A cooling arrangement in a turbine section of gas turbine engines is used to direct cooling air within shroud segment platforms for cooling the turbine shroud while forming substantially straight cooling air streams for impingement cooling on a turbine vane outer shroud.

### TECHNICAL FIELD

The invention relates generally to gas turbine engines and more particularly to turbine shroud and downstream vane outer shroud cooling.

### BACKGROUND OF THE ART

A gas turbine engine usually includes a hot section, i.e., a turbine section which includes at least one rotor stage, for example, having a plurality of shroud segments disposed circumferentially one adjacent to another to form a shroud ring surrounding a turbine rotor, and at least one stator vane stage disposed immediately downstream and/or upstream of the rotor stage, formed with outer and inner shrouds and a plurality of radial stator vanes extending therebetween. Being exposed to very hot gases, the rotor stage and the stator vane stage need to be cooled. Since flowing coolant through the rotor and stator vane stages diminishes overall engine performance, it is typically desirable to minimize cooling flow consumption without degrading durability of components of the turbine section. Hereintofore, in various approaches for development of adequate cooling arrangements, efforts have been directed to reuse of cooling air used for cooling of an upstream component of the turbine section. For example, gas turbine engine designers have been continuously seeking improved turbine section cooling arrangements for cooling turbine shroud segments, and for further reuse of the turbine shroud segment cooling air in an effective manner to cool a downstream stator vane stage.

Accordingly, there is a need to provide an improved cooling arrangement in a gas turbine engine for effectively cooling in a serial flow relationship, both turbine shroud segments and a stator vane stage thereof.

### SUMMARY OF THE INVENTION

It is therefore an object of the present invention to provide a cooling arrangement in a gas turbine engine for cooling a portion of an outer wall of an annular gas path of a turbine section.

One aspect of the present invention therefore provides a cooling arrangement in a gas turbine engine for cooling in a serial flow relationship, both turbine shroud segments and a turbine vane outer shroud, which comprises at least one passage extending in a shroud platform of each turbine shroud segment for directing cooling air therethrough to cool the turbine shroud segment. The at least one passage of the respective turbine shroud segments further direct the cooling air in combination to impinge over substantially the entire extent of a circumference of a leading end of the turbine vane outer shroud.

Another aspect of the present invention provides gas turbine engine structure for defining a portion of an outer wall of an annular gas path of a turbine section, which comprises a turbine shroud having a platform. A turbine vane outer shroud with a plurality of vanes is disposed immediately downstream of the turbine shroud. The turbine shroud defines a plurality of passages extending in and substantially axially through the platform thereof. The passages substantially align with the turbine vane outer shroud.

A further aspect of the present invention provides a method of reusing turbine shroud cooling air for impingement cooling on a downstream turbine vane outer shroud which comprises steps of (a) directing cooling air within and through a platform of a shroud segment of a turbine shroud for cooling the turbine shroud; and (b) using the cooling air of step (a) to form a plurality of substantially straight cooling air streams axially towards a leading end of the turbine vane outer shroud for impingement cooling on the turbine vane outer shroud.

These and other aspects of the present invention will be better understood with reference to preferred embodiments described hereinafter.

### DESCRIPTION OF THE DRAWINGS

Reference is now made to the accompanying figures depicting aspects of the present invention, in which:

FIG. 1 is a schematic cross-sectional view of a gas turbine engine;

FIG. 2 is an axial cross-sectional view of a turbine shroud assembly used in the gas turbine engine of FIG. 1, in accordance with one embodiment of the present invention; and

FIG. 3 is a perspective view of a shroud segment used in the turbine shroud assembly of FIG. 2.

### DETAILED DESCRIPTION OF THE PREFERRED EMBODIMENTS

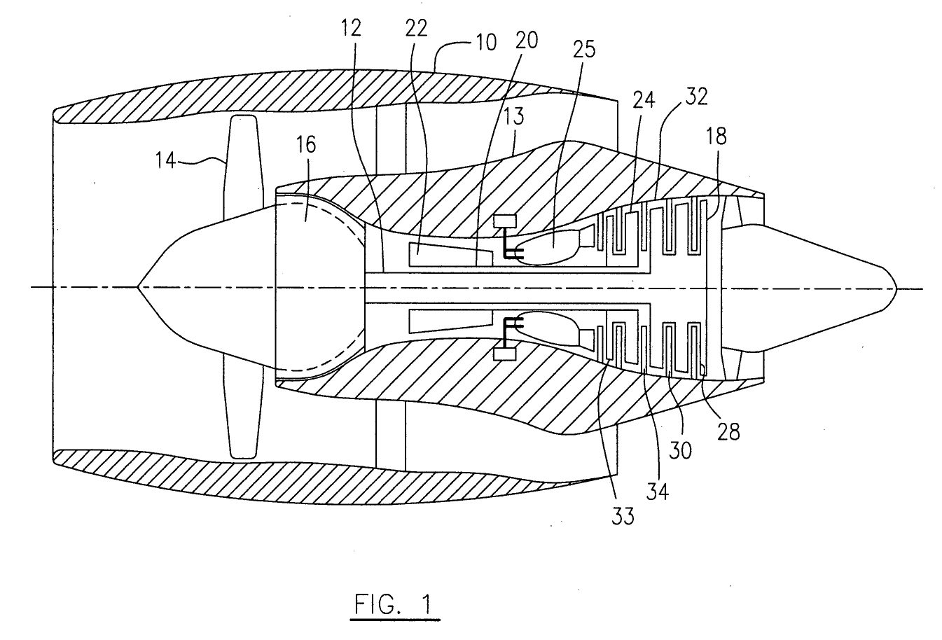

Referring to FIG. 1, a turbofan gas turbine engine incorporates an embodiment of the present invention, presented as an example of the application of the present invention, and includes a housing or a nacelle 10, a core casing 13, a low pressure spool assembly seen generally at 12 which includes a fan 14, low pressure compressor 16 and low pressure turbine 18, and a high pressure spool assembly seen generally at 20 which includes a high pressure compressor 22 and a high pressure turbine 24. There is provided a burner 25 for generating combustion gases. The low pressure turbine 18 and high pressure turbine 24 include a plurality of rotor stages 28 and stator vane stages 30.

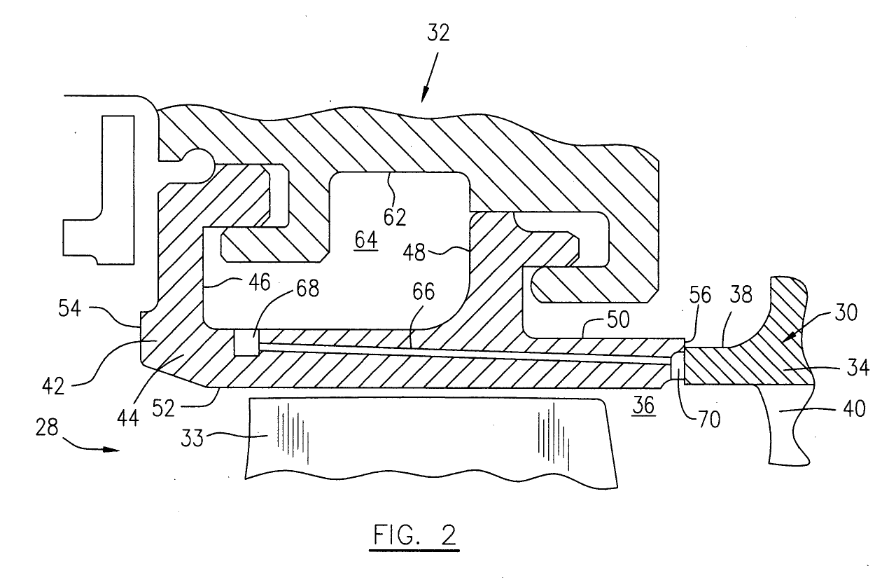

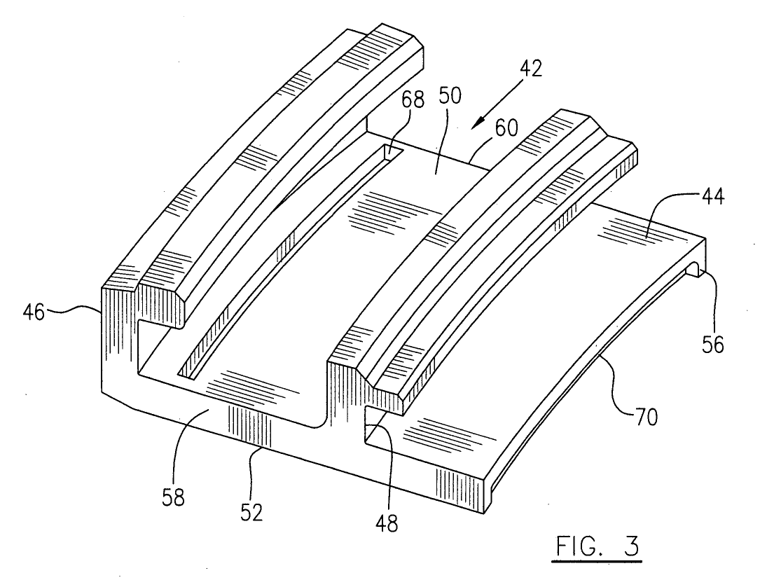

Referring to FIGS. 1-3, each of the rotor stages 28 has a plurality of rotor blades 33 encircled by a turbine shroud assembly 32 and each of the stator vane stages 30 includes a stator vane assembly 34 which is positioned upstream and/or downstream of a rotor stage 31, for directing combustion gases into or out of an annular gas path 36 within a corresponding turbine shroud assembly 32, and through the corresponding rotor stage 31.

The stator vane assembly 34, for example a first stage of a low pressure turbine (LPT) vane assembly, is disposed, for example, downstream of the shroud assembly 32 of one rotor stage 28, and includes, for example a plurality of stator vane segments (not indicated) joined one to another in a circumferential direction to form a turbine vane outer shroud 38 which comprises a plurality of axial stator vanes 40 (only a portion of one is shown) which divide a downstream section of the annular gas path 36 relative to the rotor stage 28, into sectoral gas passages for directing combustion gas flow out of the rotor stage 28.

The shroud assembly 32 in the rotor stage 28 includes a plurality of shroud segments 42 (only one shown) each of which includes a platform 44 having front and rear radial legs 46, 48 with respective hooks (not indicated). The shroud segments 42 are joined one to another in a circumferential direction and thereby form the shroud assembly 32.

The platform 44 of each shroud segment 42 has outer and inner surfaces 50, 52 and is defined axially between leading and trailing ends 54, 56, and circumferentially between opposite sides 58, 60 thereof. The platforms 44 of the segments collectively form a turbine shroud ring (not indicated) which encircles the rotor blades 33 and in combination with the rotor stage 28, defines a section of the annular gas path 36. The turbine shroud ring is disposed immediately upstream of and abuts the turbine vane outer shroud 38, to thereby form a portion of an outer wall (not indicated) of the annular gas path 36.

The front and rear radial legs 46, 48 are axially spaced apart and integrally extend from the outer surface 50 radially and outwardly such that the hooks of the front a rear radial legs 46, 48 are conventionally connected with an annular shroud support structure 62 which is formed with a plurality of shroud support segments (not indicated) and is in turn supported within the core casing 13. An annular cavity 64 is thus defined axially between the front and rear legs 46, 48 and radially between the platforms 44 of the shroud segments 42 and the annular shroud support structure 62. The annular middle cavity is in fluid communication with a cooling air source, for example bleed air from the low or high pressure compressors 16, 22 and thus the cooling air under pressure is introduced into and accommodated within the annular cavity 64.

The platform 44 of each shroud segment 42 preferably includes a passage, for example a plurality of holes 66 extending axially within the platform 44 for directing cooling air therethrough for transpiration cooling of the platform 44. For convenience of the hole drilling, a groove 68 extending in a circumferential direction with opposite ends closed is provided, for example, on the outer surface 50 of the platform 44 such that holes 66 can be drilled from the trailing end 56 of the platform straightly and axially towards and terminate at the groove 68. Thus, the groove 68 forms a common inlet of the holes 66 for intake of cooling air accommodated within the cavity 64. However, other types of outlets can be made to achieve the convenience of the hole drilling process. It is also preferable to provide one or more outlets of the holes 66 in order to adequately discharge the cooling air from the holes 66 and reduce the contact surface of the trailing end 56 of the platform 44 of the shroud segments 42 with respect to the turbine vane outer shroud 38. For example, an elongate recess 70 is provided in the trailing end 56 of the platform 44 with an opening on the inner surface 52 of the platform 44, thereby forming a common outlet of the holes 66 to discharge the cooling air, for example to the gas path 36. Other types of outlets can be used for adequately discharging the cooling air from the holes 66.

The groove 68 is in fluid communication with the middle cavity 64 and thus cooling air introduced into the cavity 64 is directed into and through the axial holes 66 for effectively cooling the platform 44 of the shroud segments 42. The cooling air is then discharged through the elongate recess 70 at the trailing end 56 of the platform 42, impinging on a downstream engine part such as the turbine vane outer shroud 38, before entering the gas path 36.

The groove 68 which functions as the common inlet of the holes 66 is preferably located close to the front leg 46 such that the holes 66 extend through a major section of the entire axial length of the platform 44 of the shroud segment 42, thereby efficiently cooling the platform 44 of the shroud segment 42.

The holes 66 are preferably substantially evenly spaced apart in a circumferential direction and are preferably aligned with the turbine vane outer shroud. Thus, the cooling air impinges on the leading end of the turbine vane outer shroud 38. The number of holes 66 in each shroud segment 42 is determined such that the cooling air discharged from the holes 66 effectively cools the entire circumference of the leading end of the turbine vane outer shroud 38.

During engine operation, cooling air introduced into the cavity 64 is directed within and through the platforms 44 of the shroud segments 42 via the holes 66, in order to cool the turbine shroud ring. Simultaneous with cooling of the turbine shroud ring, cooling air flowing through the substantially axial straight holes 66 forms a plurality of substantially straight axial cooling air streams directed towards the leading end of the turbine vane outer shroud 38, preferably with a high velocity thereof, for impingement cooling on the turbine vane outer shroud 38. In contrast to conventional impingement holes defined in a plate, the substantially axial straight holes 66 direct the cooling air through the entire length thereof, thereby forming substantially straight cooling air streams with relatively high directionality. In other words, the substantially straight cooling air streams are more individually focused and interfere less with adjacent air streams when approaching the leading end of the turbine vane outer shroud 38, which results in greater impingement effects on the leading end of the turbine vane outer shroud 38. Due to the restriction of the elongate recess 70 in the trailing end 56 of the platforms 44, the cooling air upon impingement on the leading end of the turbine vane outer shroud 38, is then directed radially, inwardly and rearwardly, thereby further film cooling a front portion of the inner surface of the turbine vane outer shroud 38 and a portion of the axial stator vanes 40, prior to being discharged into the annular gas path 36.

The above description is meant to be exemplary only, and one skilled in the art will recognize that changes may be made to the embodiments described without departure from the scope of the invention disclosed. For example, the present invention can be applicable in any type of gas turbine engine other than the described turbofan gas turbine engine. Other modifications which fall within the scope of the present invention will be apparent to those skilled in the art, in light of a review of this disclosure, and such modifications are intended to fall within the appended claims.

1. A cooling arrangement in a turbine section of a gas turbine engine for cooling in a serial flow relationship, both turbine shroud segments and a turbine vane outer shroud, the cooling arrangement comprising at least one passage extending in a shroud platform of each turbine shroud segment for directing cooling air therethrough to cool the turbine shroud segment, the at least one passage of the respective turbine shroud segments further directing the cooling air in combination to impinge over substantially the entire extent of a circumference of a leading end of the turbine vane outer shroud.

2. The cooling arrangement as claimed in claim 1 wherein the at least one passage extends through a major section of an entire axial length of the shroud platform.

3. The cooling arrangement as claimed in claim 2 wherein the at least one passage is in fluid communication with a cavity defined between front and rear legs of the turbine shroud segment.

4. The cooling arrangement as claimed in claim 3 wherein the at least one passage discharges the cooling air at a trailing end of the shroud platform for impingement on the turbine vane outer shroud.

5. The cooling arrangement as claimed in claim 4 wherein the at least one passage comprises a plurality of substantially axial straight holes.

6. A gas turbine engine structure for defining a portion of an outer wall of an annular gas path of a turbine section, comprising a turbine shroud having a platform, and a turbine vane outer shroud with a plurality of vanes disposed immediately downstream of the turbine shroud, the turbine shroud defining a plurality of passages extending in and substantially axially through the platform thereof, the passages substantially aligning with the turbine vane outer shroud.

7. The gas turbine engine structure as claimed in claim 6 wherein the passages comprise a plurality of holes having at least one inlet thereof on an outer surface of the platform and at least one outlet thereof on a trailing end of the platform.

8. The gas turbine engine structure as claimed in claim 7 wherein the at least one inlet of the holes is located in a position close to and downstream a front leg of the shroud.

9. The gas turbine engine structure as claimed in claim 7 wherein the holes extend in a substantially straight direction over a major section of the entire axial length of the platform.

10. A method of reusing turbine shroud cooling air for impingement cooling on a downstream turbine vane outer shroud, the method comprising steps of:
(a) directing cooling air within and through a platform of a shroud segment of a turbine shroud for cooling the turbine shroud; and
(b) using the cooling air of step (a) to form a plurality of substantially straight cooling air streams axially towards a leading end of the turbine vane outer shroud for impingement cooling on the turbine vane outer shroud.

11. The method as claimed in claim 10 wherein steps (a) and (b) are conducted substantially simultaneously.

12. The method as claimed in claim 11 wherein steps (a) and (b) are practiced by directing the cooling air through a plurality of substantially axial and straight passages extending within the platform of the shroud segment of the turbine shroud to deliver the substantially straight cooling air streams with a high velocity thereof.

13. The method as claimed in claim 12 wherein the cooling air is directed from a cavity defined between front and rear legs of the shroud segment, into the substantially axial and straight passages, and is discharged therefrom at a trailing end of the platform.

14. The method as claimed in claim 10 further comprising a step (c) of discharging the cooling air into a gas path upon the impingement cooling thereof on the turbine vane outer shroud.

15. The method as claimed in claim 10 comprising directing the substantially straight cooling air streams in a manner for impingement cooling on a substantially entire circumference of the leading end of the turbine vane outer shroud.
